(19) United States
(12) Patent Application Publication
(10) Pub. No.: US 2025/0166884 A1
(43) Pub. Date: May 22, 2025

(54) Integrated Magnetic Apparatus

(71) Applicant: AA Power Inc., Boston, MA (US)

(72) Inventor: Qun Lu, Lexington, MA (US)

(21) Appl. No.: 18/952,887

(22) Filed: Nov. 19, 2024

Related U.S. Application Data
(60) Provisional application No. 63/601,170, filed on Nov. 20, 2023.

(51) Int. Cl. H01F 27/30; H01F 27/24; H01F 27/36; H02M 3/335

(52) U.S. Cl. CPC H01F 27/306; H01F 27/24; H01F 27/366; H02M 3/33576

(57) ABSTRACT

An apparatus includes a first integrated magnetic core, a second integrated magnetic core in direct contact with the first integrated magnetic core, wherein one of the first integrated magnetic core and the second integrated magnetic core comprises a plurality of legs, and a plurality of windings wound around the plurality of legs, wherein the first integrated magnetic core, the second integrated magnetic core and the plurality of windings form a plurality of transformers, and the first integrated magnetic core and the second integrated magnetic core comprise a plurality of sections, and wherein at least two sections of the plurality of sections are formed of two different magnetic materials.

### RELATED APPLICATION

This application claims the benefit of U.S. Provisional Application No. 63/601,170, filed on Nov. 20, 2023, entitled “Integrated Magnetic Apparatus,” which application is hereby incorporated herein by reference

### TECHNICAL FIELD

The present invention relates to an integrated magnetic apparatus, and, in particular embodiments, to an integrated magnetic apparatus for a distributed power conversion system providing power to high power and high load current applications.

### BACKGROUND

The distributed power conversion system has been widely adopted because of the various advantages of the distributed power conversion system. For example, a distributed power conversion system may comprise a plurality of dc/dc converters. The plurality of dc/dc converters can be placed near a load. Since the distributed power conversion system is adjacent to the load, the distributed power conversion system is able to minimizes distribution losses and provides a stable voltage under variable load conditions. The size of the dc/dc converter determines whether the dc/dc converter can be placed adjacent to the load. For an isolated power converter, the magnetic devices of the isolated power converter determine the size of the power converter. Therefore, a major design objective is often to minimize the size of the magnetic devices so as to keep the power density as high as possible.

Employing integrated magnetic devices in a power conversion system is one effective approach to minimize the size of the transformer and inductor so as to improve the power density. In an integrated magnetic device, magnetic components (e.g., transformers, inductors and the like) of a switching mode power converter is implemented in a single magnetic apparatus.

The existing integrated magnetic apparatus is designed for low power and/or low load current applications. After technologies further advance, high power and/or high load current applications such as artificial intelligence (AI) processors demand a new power delivery architecture. The present disclosure addresses this need.

### SUMMARY

These and other problems are generally solved or circumvented, and technical advantages are generally achieved, by preferred embodiments of the present disclosure which provide an integrated magnetic apparatus for a distributed power conversion system.

In accordance with an embodiment, an apparatus comprises a first integrated magnetic core, a second integrated magnetic core in direct contact with the first integrated magnetic core, wherein one of the first integrated magnetic core and the second integrated magnetic core comprises a plurality of legs, and a plurality of windings wound around the plurality of legs, wherein the first integrated magnetic core, the second integrated magnetic core and the plurality of windings form a plurality of transformers, and the first integrated magnetic core and the second integrated magnetic core comprise a plurality of sections, and wherein at least two sections of the plurality of sections are formed of two different magnetic materials.

In accordance with another embodiment, a system comprises a plurality of power converters connected between an input voltage bus and an output voltage bus, each of the plurality of power converters comprising at least one magnetic device, wherein a plurality of magnetic devices of the plurality of power converters is formed in an integrated magnetic apparatus comprising a first integrated magnetic core, a second integrated magnetic core in direct contact with the first integrated magnetic core, wherein one of the first integrated magnetic core and the second integrated magnetic core comprises a plurality of legs, and a plurality of windings wound around the plurality of legs, wherein the first integrated magnetic core, the second integrated magnetic core and the plurality of windings form a plurality of transformers, and the first integrated magnetic core and the second integrated magnetic core comprise a plurality of sections, and wherein at least two sections of the plurality of sections are formed of two different magnetic materials.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a power conversion system comprising a plurality of power converters connected between an input voltage bus and an output voltage bus in accordance with various embodiments of the present disclosure;

FIG. 2 illustrates a schematic diagram of a first implementation of the power converter shown in FIG. 1 in accordance with various embodiments of the present disclosure;

FIG. 3 illustrates a schematic diagram of a second implementation of the power converter shown in FIG. 1 in accordance with various embodiments of the present disclosure;

FIG. 4 illustrates an integrated magnetic apparatus in accordance with various embodiments of the present disclosure;

FIG. 5 illustrates an integrated magnetic apparatus having four sections in accordance with various embodiments of the present disclosure;

FIG. 6 illustrates a first implementation of the integrated magnetic apparatus shown in FIG. 5 in accordance with various embodiments of the present disclosure;

FIG. 7 illustrates a second implementation of the integrated magnetic apparatus shown in FIG. 5 in accordance with various embodiments of the present disclosure;

FIG. 8 illustrates a third implementation of the integrated magnetic apparatus shown in FIG. 5 in accordance with various embodiments of the present disclosure;

FIG. 9 illustrates a fourth implementation of the integrated magnetic apparatus shown in FIG. 5 in accordance with various embodiments of the present disclosure;

FIG. 10 illustrates a fifth implementation of the integrated magnetic apparatus shown in FIG. 5 in accordance with various embodiments of the present disclosure;

FIG. 11 illustrates a sixth implementation of the integrated magnetic apparatus shown in FIG. 5 in accordance with various embodiments of the present disclosure;

FIG. 12 illustrates a seventh implementation of the integrated magnetic apparatus shown in FIG. 5 in accordance with various embodiments of the present disclosure;

FIG. 13 illustrates an eighth implementation of the integrated magnetic apparatus shown in FIG. 5 in accordance with various embodiments of the present disclosure;

FIG. 14 illustrates a ninth implementation of the integrated magnetic apparatus shown in FIG. 5 in accordance with various embodiments of the present disclosure;

FIG. 15 illustrates a tenth implementation of the integrated magnetic apparatus shown in FIG. 5 in accordance with various embodiments of the present disclosure;

FIG. 16 illustrates an eleventh implementation of the integrated magnetic apparatus shown in FIG. 5 in accordance with various embodiments of the present disclosure;

FIG. 17 illustrates a twelfth implementation of the integrated magnetic apparatus shown in FIG. 5 in accordance with various embodiments of the present disclosure;

FIG. 18 illustrates a thirteenth implementation of the integrated magnetic apparatus shown in FIG. 5 in accordance with various embodiments of the present disclosure;

FIG. 19 illustrates a fourteenth implementation of the integrated magnetic apparatus shown in FIG. 5 in accordance with various embodiments of the present disclosure;

FIG. 20 illustrates a fifteenth implementation of the integrated magnetic apparatus shown in FIG. 5 in accordance with various embodiments of the present disclosure;

FIG. 21 illustrates a sixteenth implementation of the integrated magnetic apparatus shown in FIG. 5 in accordance with various embodiments of the present disclosure;

FIG. 22 illustrates another integrated magnetic apparatus having four sections in accordance with various embodiments of the present disclosure;

FIG. 23 illustrates a first implementation of the integrated magnetic apparatus shown in FIG. 22 in accordance with various embodiments of the present disclosure; and

FIG. 24 illustrates a second implementation of the integrated magnetic apparatus shown in FIG. 22 in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure will be described with respect to preferred embodiments in a specific context, namely an integrated magnetic apparatus for a distributed power conversion system. The disclosure may also be applied, however, to a variety of power conversion systems. Hereinafter, various embodiments will be explained in detail with reference to the accompanying drawings.

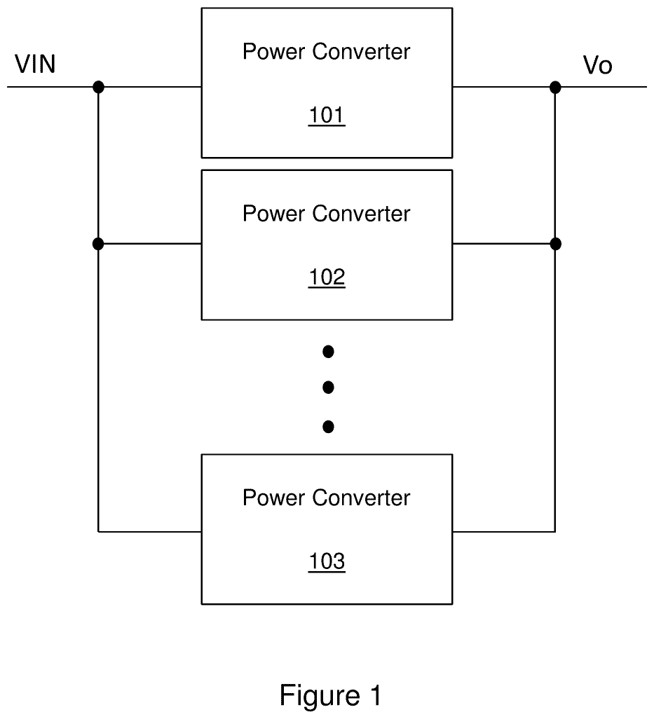

FIG. 1 illustrates a block diagram of a power conversion system comprising a plurality of power converters connected between an input voltage bus and an output voltage bus in accordance with various embodiments of the present disclosure. As shown in FIG. 1, a first power converter 101 is connected between an input voltage bus VIN and an output voltage bus Vo. The first power converter 101 comprises a plurality of first power switches and at least one magnetic device (e.g., transformer). A second power converter 102 is connected between the input voltage bus VIN and the output voltage bus Vo. The second power converter 102 comprises a plurality of second power switches and at least one magnetic device (e.g., transformer). A third power converter 103 is connected between the input voltage bus VIN and the output voltage bus Vo. The third power converter 103 comprises a plurality of third power switches and at least one magnetic device (e.g., transformer).

A load (not shown) is coupled to the output voltage bus Vo. In some embodiments, the load comprises a plurality of crypto miners in a crypto farm. Each crypto miner may comprise a plurality of graphics processing units (GPUs), a plurality of application-specific integrated chips (ASICs), any combinations thereof and the like.

In some embodiments, the power conversion system shown in FIG. 1 is a distributed power conversion system is employed to provide power for load such as an artificial intelligence (AI) processor. The peak current of the AI processor is up to 2000 amperes. The supply voltage of the AI processor is in a range from 0.5 V to 0.6 V. The distributed power conversion system is coupled between an input voltage bus such as a 48-V voltage bus and the load. The distributed power conversion system comprises a plurality of power converters connected in parallel between the input voltage bus and the load. The power converters may be implemented as inductor-inductor-capacitor (LLC) resonant converters, fly-forward converters, forward converters, flyback converters, full-bridge converters, half-bridge converters, push-pull converters, any combinations thereof and the like. Each power converter may comprise a transformer and/or an inductor. The plurality of transformers and/or the plurality of inductors of the distributed power conversion system are formed by an integrated magnetic apparatus.

In some embodiments, the integrated magnetic apparatus comprises a first integrated magnetic core, a second integrated magnetic core and a plurality of windings. The second integrated magnetic core is in direct contact with the first integrated magnetic core. One of the first integrated magnetic core and the second integrated magnetic core comprises a plurality of legs. The plurality of windings is around the plurality of legs. The first integrated magnetic core, the second integrated magnetic core and the plurality of windings form the plurality of transformers and/or the plurality of inductors of the distributed power conversion system.

In some embodiments, the first integrated magnetic core comprises a plurality of first sections. The second integrated magnetic core comprises a plurality of second sections. At least two sections of the plurality of first sections and the plurality of second sections are formed of two different magnetic materials. In some embodiments, one first section of the first integrated magnetic core is formed of a first magnetic material. The rest of the integrated magnetic apparatus is formed of a second magnetic material. In some embodiments, one second section of the second integrated magnetic core is formed of a first magnetic material. The rest of the integrated magnetic apparatus is formed of a second magnetic material. In some embodiments, two first sections of the first integrated magnetic core are formed of a first magnetic material and a second magnetic material, respectively. The rest of the integrated magnetic apparatus is formed of a third magnetic material. In some embodiments, two second sections of the second integrated magnetic core are formed of a first magnetic material and a second magnetic material, respectively. The rest of the integrated magnetic apparatus is formed of a third magnetic material. In some embodiments, a first section of the first integrated magnetic core and a second section of the second integrated magnetic core are formed of a first magnetic material and a second magnetic material, respectively. The rest of the integrated magnetic apparatus is formed of a third magnetic material.

In some embodiments, the plurality of transformers and the plurality of inductors are magnetic devices of a plurality of power converters. The plurality of power converters forms a distributed power conversion system. The distributed power conversion system is configured to provide power for a load having a load level up to 2000 amperes.

In some embodiments, a heat sink is placed over the load. The load is a processor mounted on a printed circuit board. There is a gap between the heat sink and the printed circuit board. The distributed power conversion system is placed underneath the heat sink. In other words, the height of the integrated magnetic apparatus is low enough such that the gap can accommodate the integrated magnetic apparatus.

In some embodiments, the integrated magnetic apparatus is formed of two different magnetic materials. One of the two different magnetic materials is a ferrite material, and the other of the two different magnetic materials is a polycrystalline ferromagnetic material.

In some embodiments, the integrated magnetic apparatus is formed of two different magnetic materials. One of the two different magnetic materials is a ferrite material, and the other of the two different magnetic materials is a ferromagnetic material.

In some embodiments, a groove is formed in one of the first integrated magnetic core and the second integrated magnetic core. In some embodiments, the groove is embedded in one of the first integrated magnetic core and the second integrated magnetic core, and the groove is configured to adjust a flux direction of the integrated magnetic apparatus.

In some embodiments, the groove extends through one of the first integrated magnetic core and the second integrated magnetic core, and the groove is configured to adjust a flux direction of the integrated magnetic apparatus.

In some embodiments, the groove extends partially through one of the first integrated magnetic core and the second integrated magnetic core, and the groove is configured to adjust a flux direction of the integrated magnetic apparatus.

In some embodiments, a magnetic material is filled in the groove. The magnetic material filled in the groove is different from the magnetic material of the rest of the integrated magnetic apparatus.

In some embodiments, an electromagnetic interference (EMI) shielding layer is coated over the groove. In particular, once the magnetic material is filled in the groove, a planarization process is performed on the top surface of the integrated magnetic core so that the top surface of the magnetic material is level with the top surface of the integrated magnetic core. The EMI shielding layer is coated on the planar surface to cover the groove. In alternative embodiments, the magnetic material is partially filled in the groove. The EMI shielding layer is formed over the magnetic material until the top surface of the EMI shielding layer is level with the top surface of the integrated magnetic core.

In some embodiments, a magnetic layer is formed in one of the first integrated magnetic core and the second integrated magnetic core. The magnetic layer is formed from a different magnetic material from the rest of the first integrated magnetic core and the second integrated magnetic core.

The magnetic layer may be formed in the first integrated magnetic core. The first integrated magnetic core is an I core. The I core is rectangular in shape. From a top view of the I core, a length of a first side of the I core is greater than a length of a second side of the I core.

In some embodiments, the magnetic layer is rectangular in shape. From a top view, the magnetic layer is narrower than the first integrated magnetic core. In one embodiment, the magnetic layer is formed along the first side of the first integrated magnetic core. In another embodiment, the magnetic layer is formed along the second side of the first integrated magnetic core.

In some embodiments, an opening is formed over one leg. The opening is filled with a different magnetic material from the rest of the first integrated magnetic core and the second integrated magnetic core.

In some embodiments, a first opening is formed over a first leg. A second opening is formed over a second leg. The first opening is filled with a first magnetic material from the rest of the first integrated magnetic core and the second integrated magnetic core. The second opening is filled with a second magnetic material from the rest of the first integrated magnetic core and the second integrated magnetic core.

In some embodiments, a first groove is formed in one of the first integrated magnetic core and the second integrated magnetic core. A second groove is formed in one of the first integrated magnetic core and the second integrated magnetic core. In some embodiments, the first groove is orthogonal to the second groove. In alternative embodiments, the first groove is parallel with the second groove.

In some embodiments, a first groove is formed in the first integrated magnetic core. A second groove is formed in the second integrated magnetic core. In some embodiments, the first groove is orthogonal to the second groove. In alternative embodiments, the first groove is parallel with the second groove.

In some embodiments, a first groove is formed in the first integrated magnetic core. A second groove is formed in the first integrated magnetic core. In some embodiments, the first groove is orthogonal to the second groove. In alternative embodiments, the first groove is parallel with the second groove.

In some embodiments, a first groove is formed in the second integrated magnetic core. A second groove is formed in the second integrated magnetic core. In some embodiments, the first groove is orthogonal to the second groove. In alternative embodiments, the first groove is parallel with the second groove.

In some embodiments, the first integrated magnetic core is an I core. The second integrated magnetic core is an E core comprising the plurality of legs arranged in a row.

In some embodiments, the first integrated magnetic core is an I core. The second integrated magnetic core is an E core comprising the plurality of legs in at least two rows.

In some embodiments, the plurality of transformers and/or the plurality of inductors are magnetic devices of a plurality of power converters. The plurality of power converters forms a distributed power conversion system having an output voltage in a range from about 0.5 V to about 0.6 V.

In some embodiments, the plurality of transformers and/or the plurality of inductors are magnetic devices of a plurality of isolated fly-forward power converters. Each of the plurality of isolated fly-forward power converters has an input voltage range from 0 V to 48 V.

In some embodiments, the plurality of transformers and/or the plurality of inductors are magnetic devices of a plurality of isolated forward power converters. Each of the plurality of isolated forward power converters has an input voltage range from 0 V to 48 V.

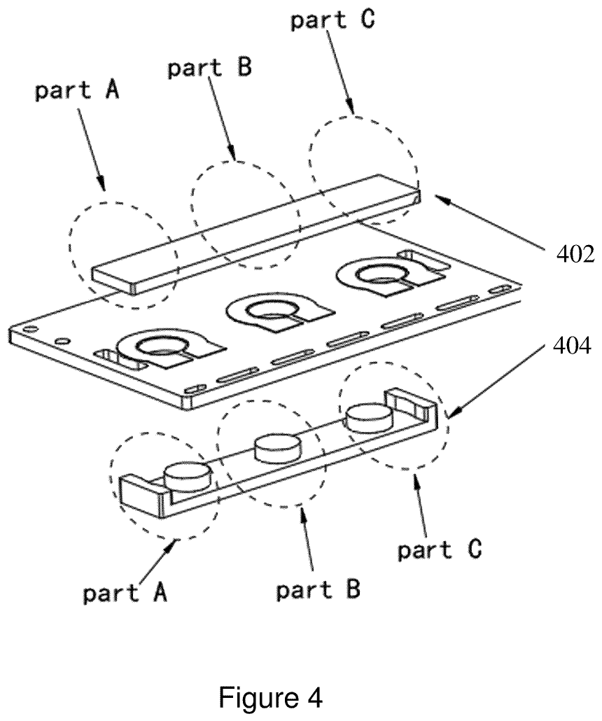

The detailed implementations of the integrated magnetic apparatus described above will be discussed below with respect to FIGS. 4-24.

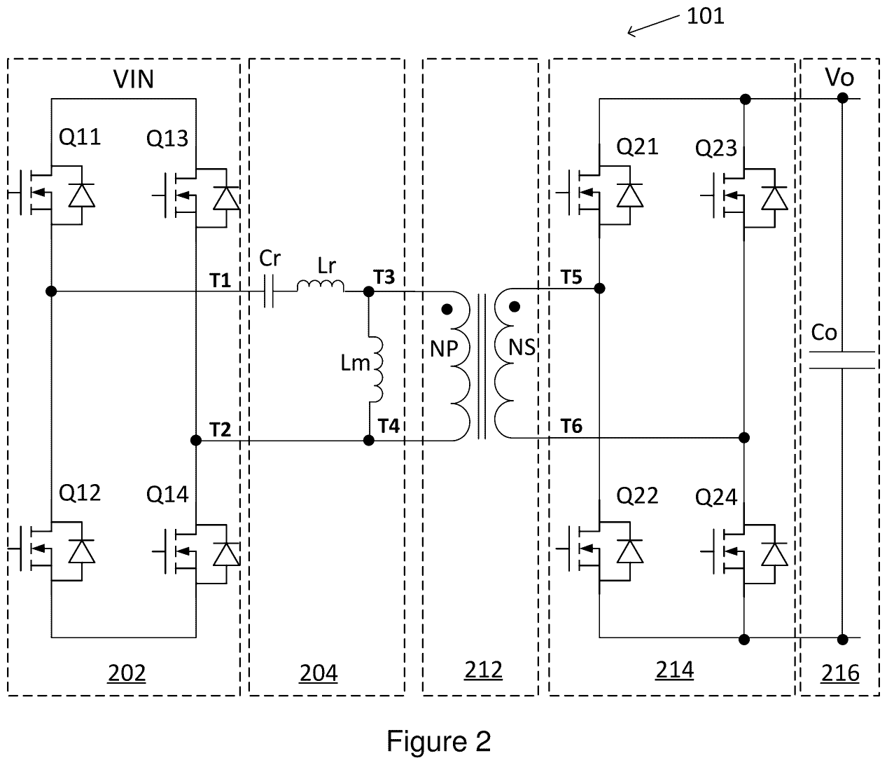

FIG. 2 illustrates a schematic diagram of a first implementation of the power converter shown in FIG. 1 in accordance with various embodiments of the present disclosure. In some embodiments, the power converter (e.g., 101) is implemented as an LLC resonant converter. As shown in FIG. 2, the LLC resonant converter comprises a switch network 202, a resonant tank 204, a transformer 212, a rectifier 214 and an output filter 216. As shown in FIG. 2, the switch network 202, the resonant tank 204, the transformer 212, the rectifier 214 and the output filter 216 are coupled to each other and connected in cascade between the input voltage bus VIN and the output voltage bus Vo.

The switch network 202 includes four switching elements, namely Q11, Q12, Q13 and Q14. Throughout the description, the switch network 202 is alternatively referred to as a primary switch network.

As shown in FIG. 2, a first pair of switching elements Q11 and Q12 are connected in series between the input voltage bus VIN and a primary ground. A second pair of switching elements Q13 and Q14 are connected in series between the input voltage bus VIN and the primary ground. The common node of the switching elements Q11 and Q12 is coupled to a first input terminal T1 of the resonant tank 204. Likewise, the common node of the switching elements Q13 and Q14 is coupled to a second input terminal T2 of the resonant tank 204.

FIG. 2 further illustrates the resonant tank 204 is coupled between the switch network 202 and the transformer 212. The resonant tank 204 is formed by a series resonant inductor Lr, a series resonant capacitor Cr and a parallel inductance Lm. As shown in FIG. 2, the series resonant inductor Lr and the series resonant capacitor Cr are connected in series and further coupled to the primary side of the transformer 212.

It should be noted while FIG. 2 shows the series resonant inductor Lr is an independent component, the series resonant inductor Lr may be replaced by the leakage inductance of the transformer 212. In other words, the leakage inductance (not shown) may function as the series resonant inductor Lr.

It should further be noted while FIG. 2 shows the resonant tank is placed on the primary side of the LLC resonant converter, this diagram is merely an example. A person skilled in the art will recognize many variations, alternatives and modifications. For example, the resonant tank may be placed on the secondary side. Furthermore, the resonant tank may be placed on both sides of the transformer 212.

The transformer 212 has a primary winding NP and a secondary winding NS. The primary winding is coupled to terminals T3 and T4 of the resonant tank 204 as shown in FIG. 2. The secondary winding is coupled to the output of the LLC resonant converter through the rectifier 214, which is a full-bridge rectifier comprising switches Q21, Q22, Q23 and Q24. Throughout the description, the rectifier 214 is alternatively referred to as a secondary switch network.

As shown in FIG. 2, switches Q21 and Q22 are connected in series and further coupled between two terminals of the output capacitor Co. Switches Q23 and Q24 are connected in series and further coupled between the two terminals of the output capacitor Co. The common node T5 of the switches Q21 and Q22 is coupled to a first terminal of the secondary winding of the transformer 212. Likewise, the common node T6 of the switches Q23 and Q24 is coupled to a second terminal of the secondary winding of the transformer 212.

It should be noted that the transformer structure shown in FIG. 2 is merely an example. One person skilled in the art will recognize many alternatives, variations and modification. For example, the secondary side of the transformer 212 may be a center tapped transformer winding. As a result, the secondary side may employ a synchronous rectifier formed by two switching elements. The operation principle of a synchronous rectifier coupled to a center tapped transformer winding is well known, and hence is not discussed in further detail herein to avoid repetition.

It should further be noted that the power topology of the LLC resonant converter may be not only applied to the rectifier as shown in FIG. 2, but also applied to other secondary configurations, such as voltage doubler rectifiers, current doubler rectifiers, any combinations thereof and/or the like.

In operation, when the switching frequency of the LLC resonant converter is equal to the resonant frequency of the resonant tank of the LLC resonant converter, the LLC resonant converter may have a unity system gain. On the other hand, when the switching frequency of the LLC resonant converter is higher than the resonant frequency, the LLC resonant converter is of a lower system gain.

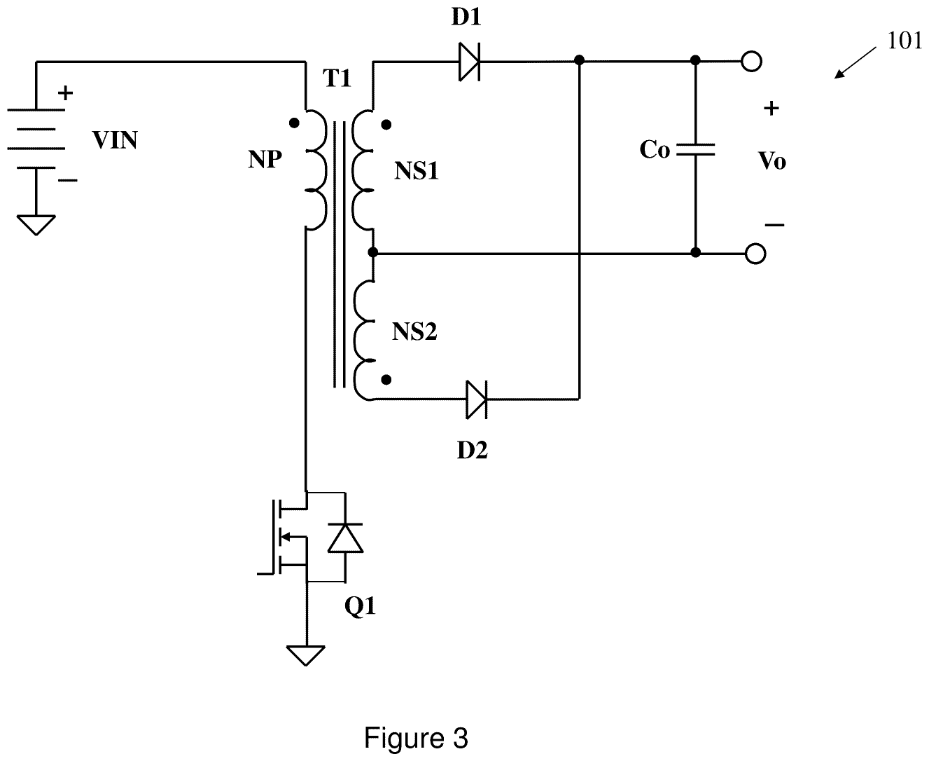

FIG. 3 illustrates a schematic diagram of a second implementation of the power converter shown in FIG. 1 in accordance with various embodiments of the present disclosure. In some embodiments, the power converter (e.g., 101) is implemented as a fly-forward converter. As shown in FIG. 3, the fly-forward converter comprises a transformer T1, a primary switch Q1, a first diode D1, a second diode D2 and an output capacitor Co. The transformer T1 comprises a primary winding NP, a first secondary winding NS1 and a second secondary winding NS2.

As shown in FIG. 3, the primary winding NP and the primary switch Q1 are connected in series between an input voltage bus and ground. The first secondary winding NS1 and the second secondary winding NS2 are connected in series and magnetically coupled to the primary winding NP. A common node of the first secondary winding NS1 and the second secondary winding NS2 is connected to a negative output terminal of the fly-forward converter. The first diode D1 is connected between the first secondary winding NS1 and a positive output terminal of the fly-forward converter. The second diode D2 is connected between the second secondary winding NS2 and the positive output terminal of the fly-forward converter. The output capacitor Co is connected between the positive output terminal and the negative output terminal of the fly-forward converter.

In operation, the fly-forward converter operates as a hybrid of flyback and forward converters, transferring energy directly through the transformer during the on time of the primary switch Q1. When the primary switch Q1 turns on, current flows through the primary winding NP of the transformer T1, inducing a proportional current in the first secondary winding NS1. This energy is delivered to the load via the first diode D1. When the primary switch Q1 turns off, the stored energy in the transformer T1 is released to the secondary side and delivered to the load through D2.

FIG. 4 illustrates an integrated magnetic apparatus in accordance with various embodiments of the present disclosure. As shown in the upper portion of FIG. 4, the integrated magnetic apparatus includes a first integrated magnetic core 402 and a second integrated magnetic core 404. These two integrated magnetic cores are mounted over a printed circuit board. As shown in FIG. 4, the first integrated magnetic core 402 is mounted over a first side of the printed circuit board. The first integrated magnetic core 402 is an I-shaped core. The second integrated magnetic core 404 is mounted over a second side of the printed circuit board. The second integrated magnetic core 404 has a base, two sidewalls over the base and three columns (legs) over the base and between the two sidewalls.

Each column (leg) and the surrounding area form a section. As shown in FIG. 4, there are three sections, namely A, B and C. These three sections may be formed of three different magnetic materials.

In some embodiments, the power conversion system shown in FIG. 1 comprises three power converters. Each power converter is implemented as a suitable power topology (e.g., a fly-forward converter). The transformer windings of the first power converter are embedded in the printed circuit board and wound around the leg of section A. The transformer windings of the second power converter are embedded in the printed circuit board and wound around the leg of section B. The transformer windings of the third power converter are embedded in the printed circuit board and wound around the leg of section C.

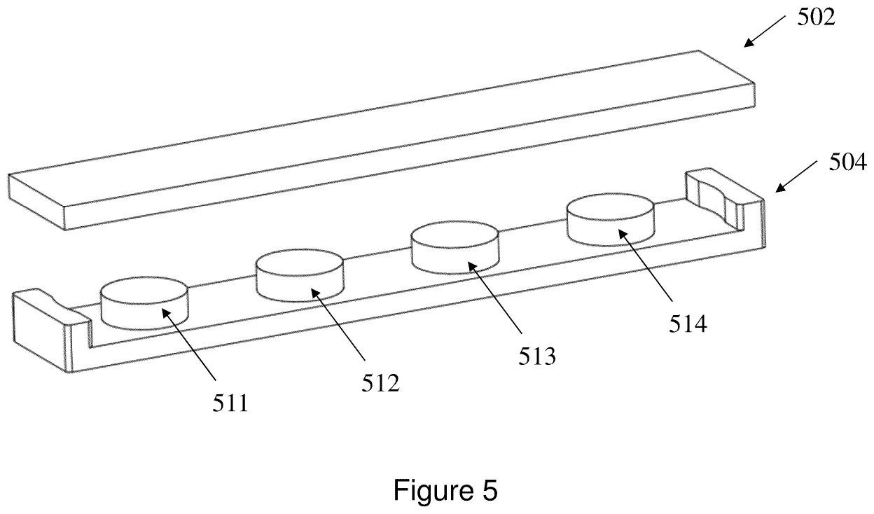

FIG. 5 illustrates an integrated magnetic apparatus having four sections in accordance with various embodiments of the present disclosure. The first integrated magnetic core 502 is an I-shaped core. The second integrated magnetic core 504 has a base, two sidewalls over the base and four columns (legs) 511, 512, 513 and 514 over the base and between the two sidewalls. These four columns (legs) may be arranged in one row as shown in FIG. 5.

In some embodiments, the power conversion system shown in FIG. 1 comprises four power converters. Each power converter is implemented as a suitable power topology (e.g., a fly-forward converter). The transformer windings of the first power converter are wound around the leg 511. The transformer windings of the second power converter are wound around the leg 512. The transformer windings of the third power converter are wound around the leg 513. The transformer windings of the fourth power converter are wound around the leg 514.

In alternative embodiments, the power conversion system shown in FIG. 1 comprises two power converters. Each power converter is implemented as a suitable power topology (e.g., an LLC resonant converter). The inductor winding of the first power converter is wound around the leg 511. The transformer windings of the first power converter are wound around the leg 512. The inductor winding of the second power converter is wound around the leg 514. The transformer windings of the second power converter are wound around the leg 513.

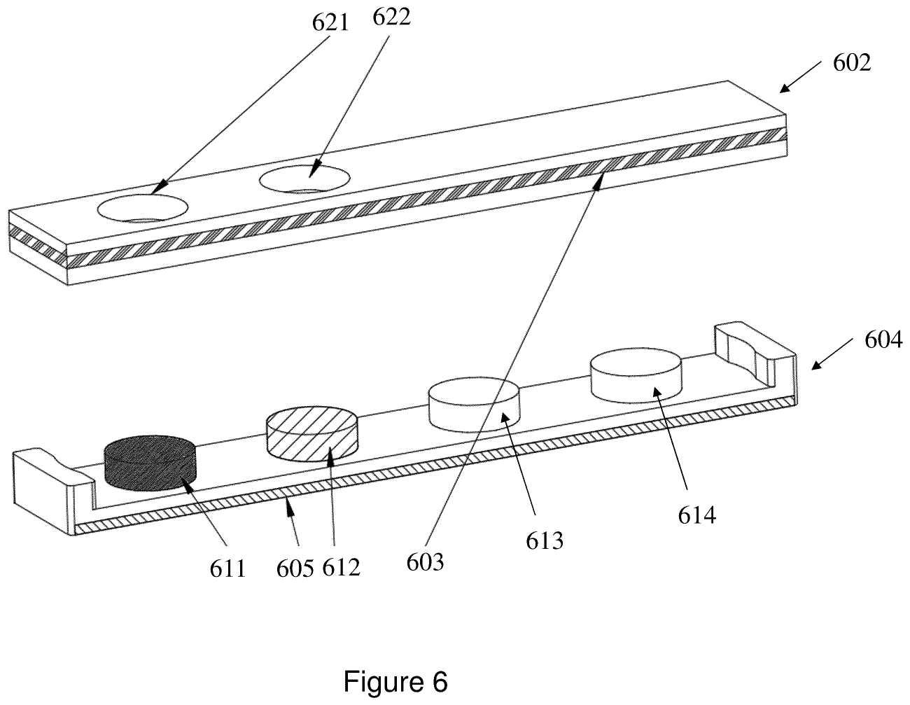

FIG. 6 illustrates a first implementation of the integrated magnetic apparatus shown in FIG. 5 in accordance with various embodiments of the present disclosure. As shown in FIG. 6, the first integrated magnetic core 602 is an I-shaped core. The second integrated magnetic core 604 has a base, two sidewalls over the base and four columns (legs) over the base and between the two sidewalls. As shown in FIG. 6, these four columns (legs) 611, 612, 613 and 614 are arranged in one row.

As shown in FIG. 6, the first integrated magnetic core 602 has a magnetic layer 603 formed in the middle portion of the first integrated magnetic core 602. This material of this magnetic layer is different from that of the rest of the first integrated magnetic core 602. As shown in FIG. 6, the second integrated magnetic core 604 has a magnetic layer 605 formed in the bottom portion of the second integrated magnetic core 604. This material of this magnetic layer is different from that of the rest of the second integrated magnetic core 604.

As shown in FIG. 6, a first opening 621 is formed in the first integrated magnetic core 602. In particular, the first opening 621 is formed over and aligned with a first leg 611. In some embodiments, the top surface of the magnetic layer 603 is a bottom of the first opening 621. A second opening 622 is formed in the first integrated magnetic core 602. In particular, the second opening 622 is formed over and aligned with a second leg 612. In some embodiments, the top surface of the magnetic layer 603 is a bottom of the second opening 622.

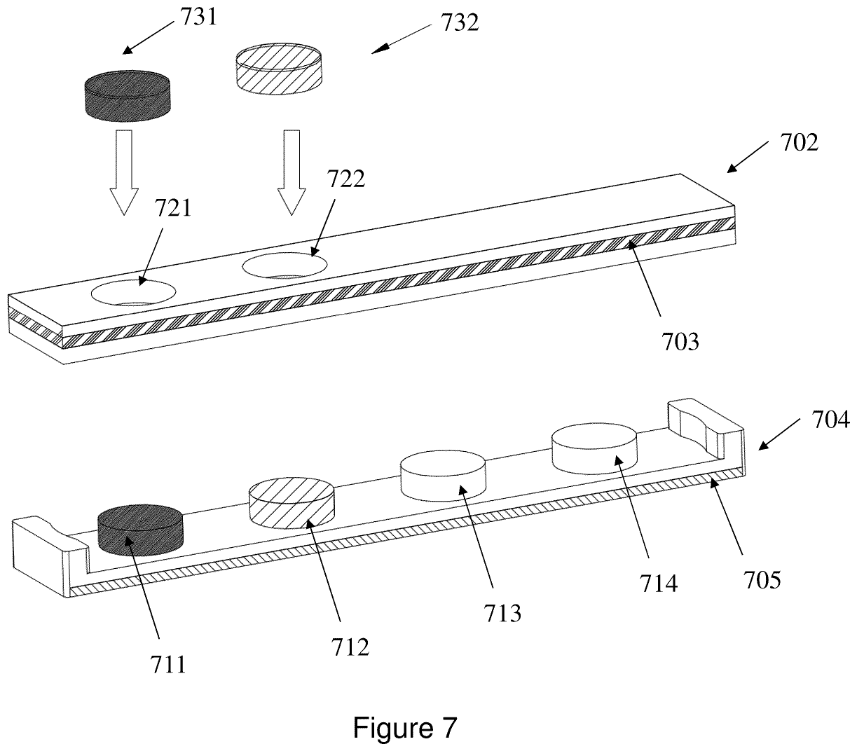

FIG. 7 illustrates a second implementation of the integrated magnetic apparatus shown in FIG. 5 in accordance with various embodiments of the present disclosure. The integrated magnetic apparatus shown in FIG. 7 is similar to that shown in FIG. 6 except that the openings extend through the first integrated magnetic core 702.

A first opening 721 is formed over and aligned with a first leg 711. A first magnetic material 731 is filled in the first opening 721. In some embodiments, the first leg 711 is also formed of the first magnetic material. A second opening 722 is formed over and aligned with a second leg 712. A second magnetic material 732 is filled in the second opening 722. In some embodiments, the second leg 712 is also formed of the second magnetic material.

In sum, the integrated magnetic apparatus shown FIG. 7 comprises five different materials. The first magnetic material 731 is filled in the first opening 721. The second magnetic material 732 is filled in the second opening 722. The magnetic layer 703 is formed of a third magnetic material. The magnetic layer 705 is formed of a fourth magnetic material. The rest of the integrated magnetic apparatus is formed of a fifth magnetic material.

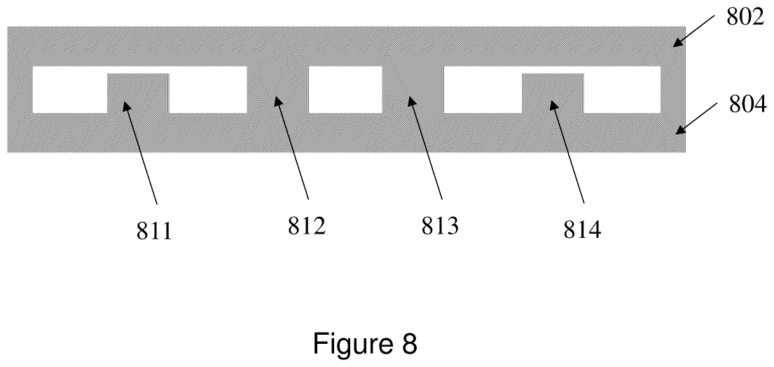

FIG. 8 illustrates a third implementation of the integrated magnetic apparatus shown in FIG. 5 in accordance with various embodiments of the present disclosure. FIG. 8 shows a cross-sectional view of the integrated magnetic apparatus. The first integrated magnetic core 802 is an I-shaped core. The second integrated magnetic core 804 has a base, two sidewalls over the base and four columns (legs) 811, 812, 813 and 814 over the base and between the two sidewalls.

As shown in FIG. 8, the first integrated magnetic core 802 is over the second integrated magnetic core 804. The bottom of the first integrated magnetic core 802 is in direct contact with the top surfaces of the legs 812 and 814. There is a first gap between the bottom of the first integrated magnetic core 802 and the top surface of the leg 811. There is a second gap between the bottom of the first integrated magnetic core 802 and the top surface of the leg 814.

Referring back to FIG. 5, the inductor winding of the first power converter is wound around a first outer leg (e.g., leg 511). The inductor winding of the second power converter is wound around a second outer leg (e.g., leg 514). The gaps between the top surfaces of the outer legs and the bottom of the first integrated magnetic core 802 helps increase the reluctance of the magnetic core. This prevents the magnetic core from being saturated, thereby allowing the inductors to store more energy in the magnetic field. In FIG. 8, the gaps over legs 811 and 814 help improve the performance of the inductors.

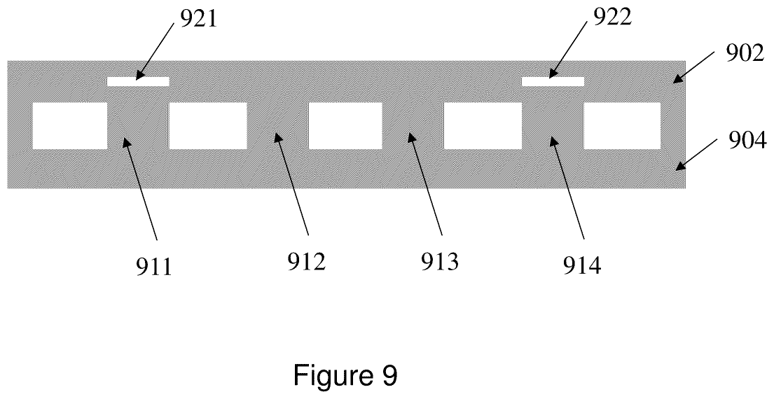

FIG. 9 illustrates a fourth implementation of the integrated magnetic apparatus shown in FIG. 5 in accordance with various embodiments of the present disclosure. FIG. 9 shows a cross-sectional view of the integrated magnetic apparatus. The first integrated magnetic core 902 is an I-shaped core. The second integrated magnetic core 904 has a base, two sidewalls over the base and four columns (legs) 911, 912, 913 and 914 over the base and between the two sidewalls.

As shown in FIG. 9, the first integrated magnetic core 902 is over the second integrated magnetic core 904. The bottom of the first integrated magnetic core 902 is in direct contact with the top surfaces of the legs 911, 912, 913 and 914. There is a first air gap 921 embedded in the first integrated magnetic core 902, and aligned with the leg 911. There is a second air gap 922 embedded in the first integrated magnetic core 902, and aligned with the leg 914.

Referring back to FIG. 5, the inductor winding of the first power converter is wound around a first outer leg (e.g., leg 511). The inductor winding of the second power converter is wound around a second outer leg (e.g., leg 514). The air gaps 921 and 922 in the first integrated magnetic core 902 helps increase the reluctance of the magnetic core. This prevents the magnetic core from being saturated, thereby allowing the inductors to store more energy in the magnetic field.

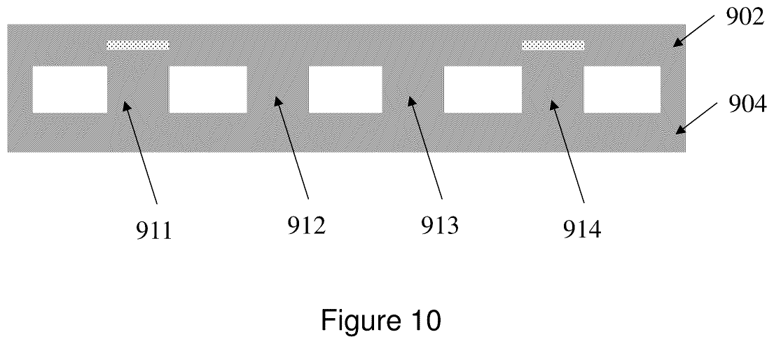

FIG. 10 illustrates a fifth implementation of the integrated magnetic apparatus shown in FIG. 5 in accordance with various embodiments of the present disclosure. FIG. 10 shows a cross-sectional view of the integrated magnetic apparatus. The fifth implementation of the integrated magnetic apparatus is similar to the fourth implementation shown in FIG. 9 except that the air gaps are filled with a suitable magnetic material.

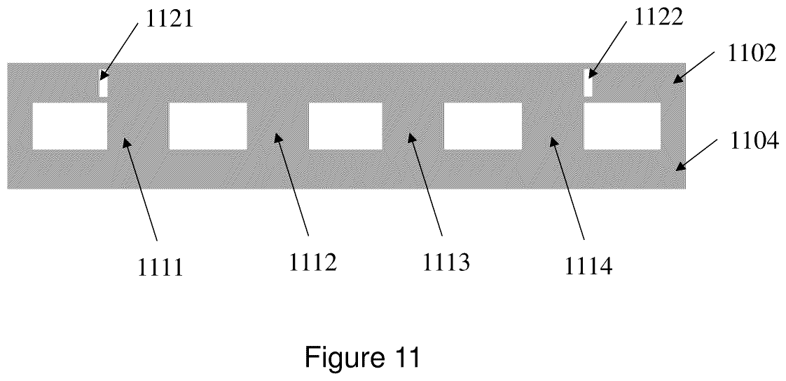

FIG. 11 illustrates a sixth implementation of the integrated magnetic apparatus shown in FIG. 5 in accordance with various embodiments of the present disclosure. FIG. 11 shows a cross-sectional view of the integrated magnetic apparatus. The first integrated magnetic core 1102 is an I-shaped core. The second integrated magnetic core 1104 has a base, two sidewalls over the base and four columns (legs) 1111, 1112, 1113 and 1114 over the base and between the two sidewalls.

As shown in FIG. 11, the first integrated magnetic core 1102 is over the second integrated magnetic core 1104. The bottom of the first integrated magnetic core 1102 is in direct contact with the top surfaces of the legs 1111, 1112, 1113 and 1114. There is a first vertical air gap 1121 embedded in the first integrated magnetic core 1102, and aligned with a first sidewall of the leg 1111. There is a second vertical air gap 1122 embedded in the first integrated magnetic core 1102, and aligned with a first sidewall of the leg 1114.

Referring back to FIG. 5, the inductor winding of the first power converter is wound around a first outer leg. The inductor winding of the second power converter is wound around a second outer leg. The vertical air gaps 1121 and 1122 in the first integrated magnetic core 1102 helps increase the reluctance of the magnetic core. This prevents the magnetic core from being saturated, thereby allowing the inductors to store more energy in the magnetic field.

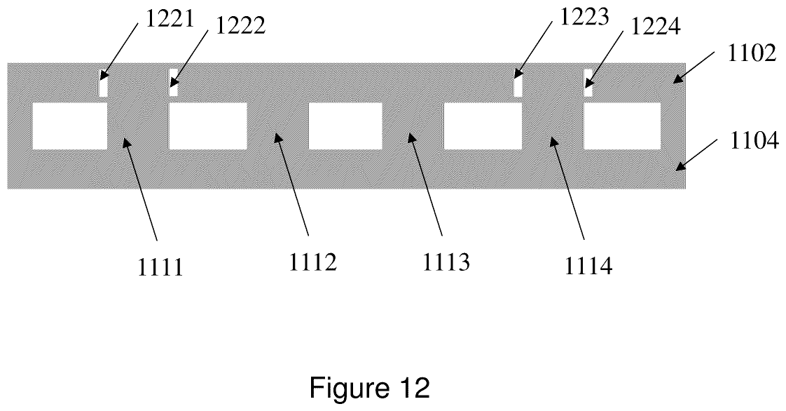

FIG. 12 illustrates a seventh implementation of the integrated magnetic apparatus shown in FIG. 5 in accordance with various embodiments of the present disclosure. FIG. 12 shows a cross-sectional view of the integrated magnetic apparatus. The seventh implementation of the integrated magnetic apparatus is similar to the sixth implementation shown in FIG. 11 except that four vertical air gaps embedded in the first integrated magnetic core 1102. As shown in FIG. 12, a first vertical air gap 1221 embedded in the first integrated magnetic core 1102, and aligned with a first sidewall of the leg 1111. A second vertical air gap 1222 embedded in the first integrated magnetic core 1102, and aligned with a second sidewall of the leg 1111. A third vertical air gap 1223 embedded in the first integrated magnetic core 1102, and aligned with a first sidewall of the leg 1114. A fourth vertical air gap 1224 embedded in the first integrated magnetic core 1102, and aligned with a second sidewall of the leg 1114.

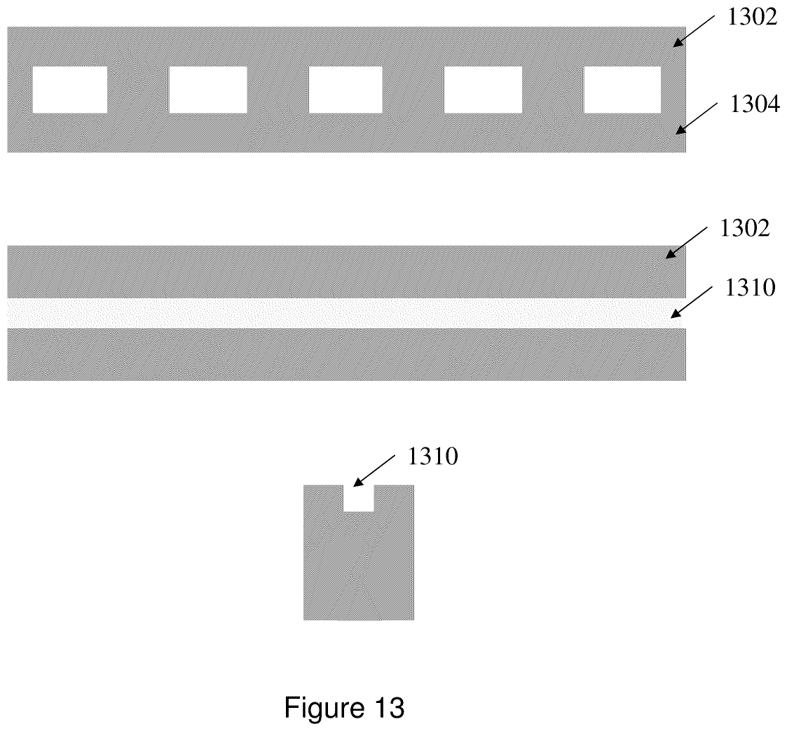

FIG. 13 illustrates an eighth implementation of the integrated magnetic apparatus shown in FIG. 5 in accordance with various embodiments of the present disclosure. FIG. 13 shows a cross-sectional view, a top view and a side view of the integrated magnetic apparatus. In the top portion of FIG. 13, the cross-sectional view shows that the first integrated magnetic core 1302 is an I-shaped core, and the second integrated magnetic core 1304 has a base, two sidewalls over the base and four columns (legs) over the base and between the two sidewalls. As shown in the cross-sectional view, the first integrated magnetic core 1302 is over the second integrated magnetic core 1304. The bottom of the first integrated magnetic core 1302 is in direct contact with the top surfaces of the legs.

In the middle portion of FIG. 13, the top view shows that a groove 1310 is formed in the first integrated magnetic core 1302. In the bottom portion of FIG. 13, the side view shows that the groove 1310 extends partially through the first integrated magnetic core 1302.

In operation, the groove 1310 is configured to adjust a flux direction of the integrated magnetic apparatus, thereby improving the performance of the integrated magnetic apparatus depending on different design needs.

It should be noted that, in alternative embodiments, the groove 1310 may be formed in the second integrated magnetic core 1304. It should further be noted that depending on design needs, the length of the groove 1310 may be shorter than the length of the first integrated magnetic core 1302.

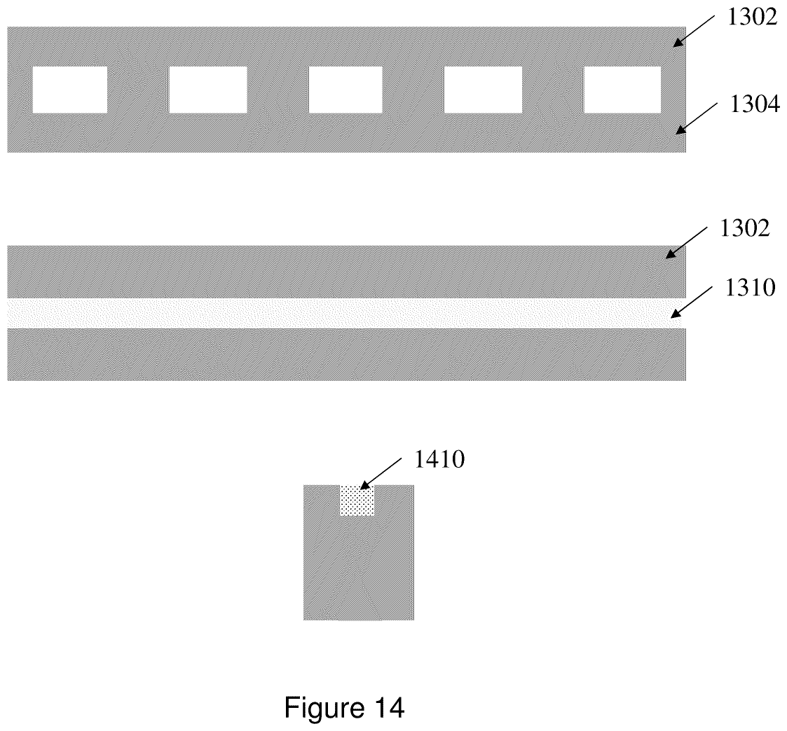

FIG. 14 illustrates a ninth implementation of the integrated magnetic apparatus shown in FIG. 5 in accordance with various embodiments of the present disclosure. FIG. 14 shows a cross-sectional view, a top view and a side view of the integrated magnetic apparatus. The ninth implementation of the integrated magnetic apparatus is similar to the eighth implementation shown in FIG. 13 except that a suitable magnetic material 1410 is filled in the groove 1310. In some embodiments, the magnetic material 1410 is different from the magnetic material of the first integrated magnetic core 1302.

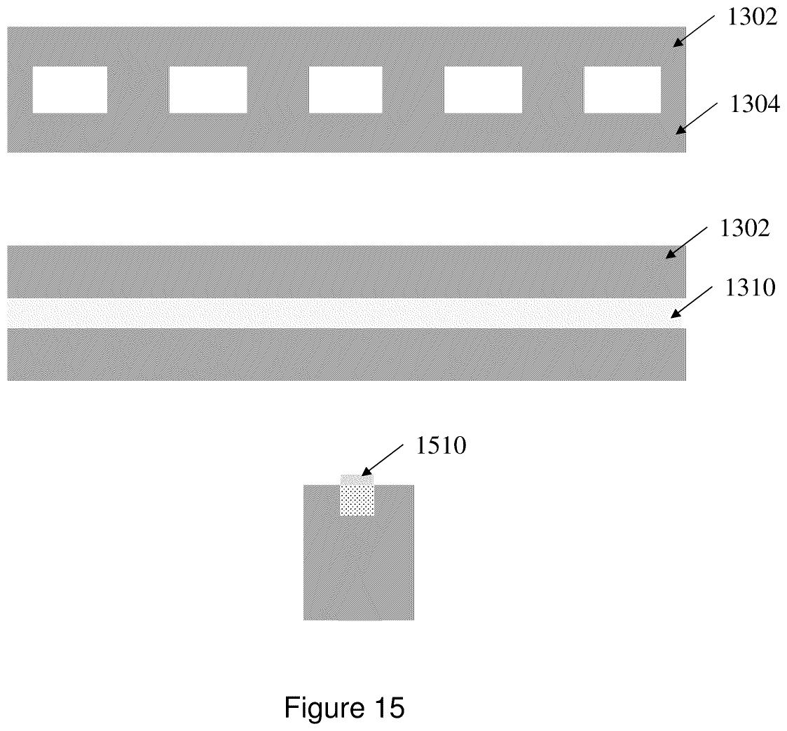

FIG. 15 illustrates a tenth implementation of the integrated magnetic apparatus shown in FIG. 5 in accordance with various embodiments of the present disclosure. FIG. 15 shows a cross-sectional view, a top view and a side view of the integrated magnetic apparatus. The tenth implementation of the integrated magnetic apparatus is similar to the ninth implementation shown in FIG. 14 except that an EMI shielding layer 1510 is formed over the groove 1310.

In some embodiments, the EMI shielding layer 1510 is coated over the groove 1310. In particular, once the magnetic material is filled in the groove 1310, a planarization process is performed on the top surface of the first integrated magnetic core 1302 so that the top surface of the magnetic material is level with the top surface of the first integrated magnetic core 1302. The EMI shielding layer 1510 is coated on the planar surface to cover the groove 1310.

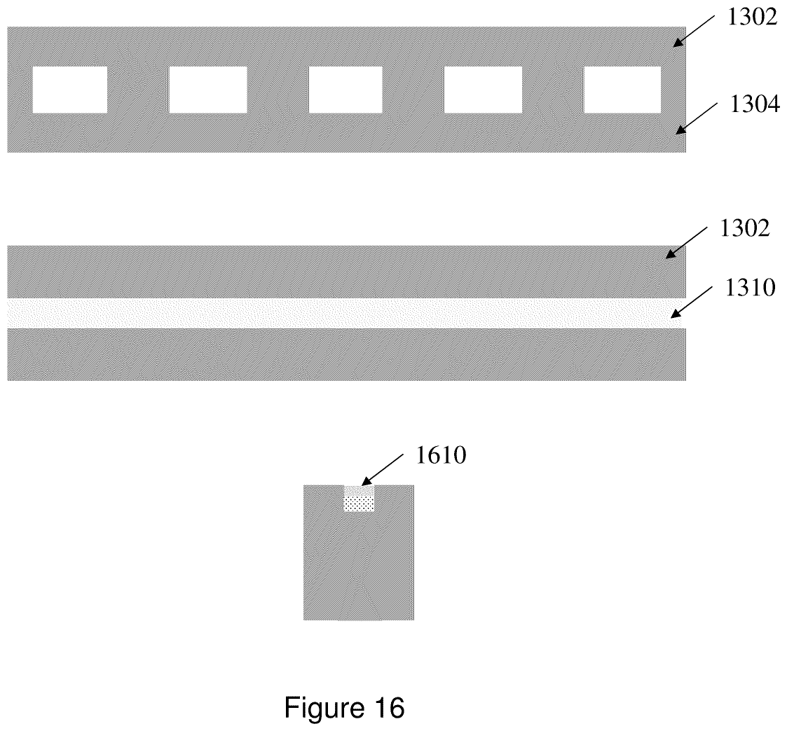

FIG. 16 illustrates an eleventh implementation of the integrated magnetic apparatus shown in FIG. 5 in accordance with various embodiments of the present disclosure. FIG. 16 shows a cross-sectional view, a top view and a side view of the integrated magnetic apparatus. The eleventh implementation of the integrated magnetic apparatus is similar to the tenth implementation shown in FIG. 15 except that an EMI shielding layer 1510 is formed inside the groove 1310. In particular, a magnetic material is partially filled in the groove 1310. The EMI shielding layer 1610 is formed over the magnetic material until the top surface of the EMI shielding layer 1610 is level with the top surface of the first integrated magnetic core 1302.

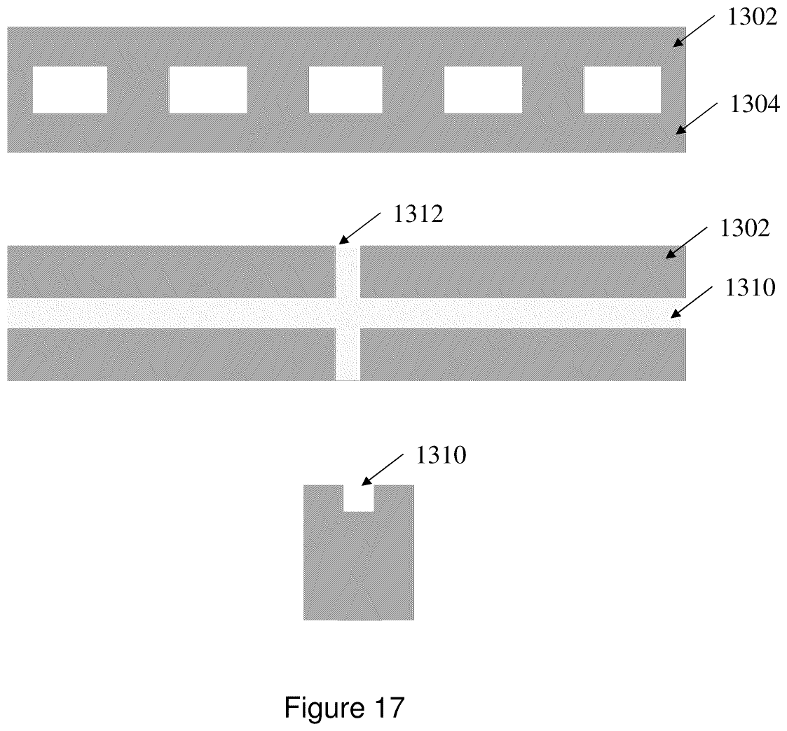

FIG. 17 illustrates a twelfth implementation of the integrated magnetic apparatus shown in FIG. 5 in accordance with various embodiments of the present disclosure. FIG. 17 shows a cross-sectional view, a top view and a side view of the integrated magnetic apparatus. The twelfth implementation of the integrated magnetic apparatus is similar to the eighth implementation shown in FIG. 13 except that a second groove 1312 is also formed in the first integrated magnetic core 1302. As shown in FIG. 17, the first groove 1310 is orthogonal to the second groove 1312.

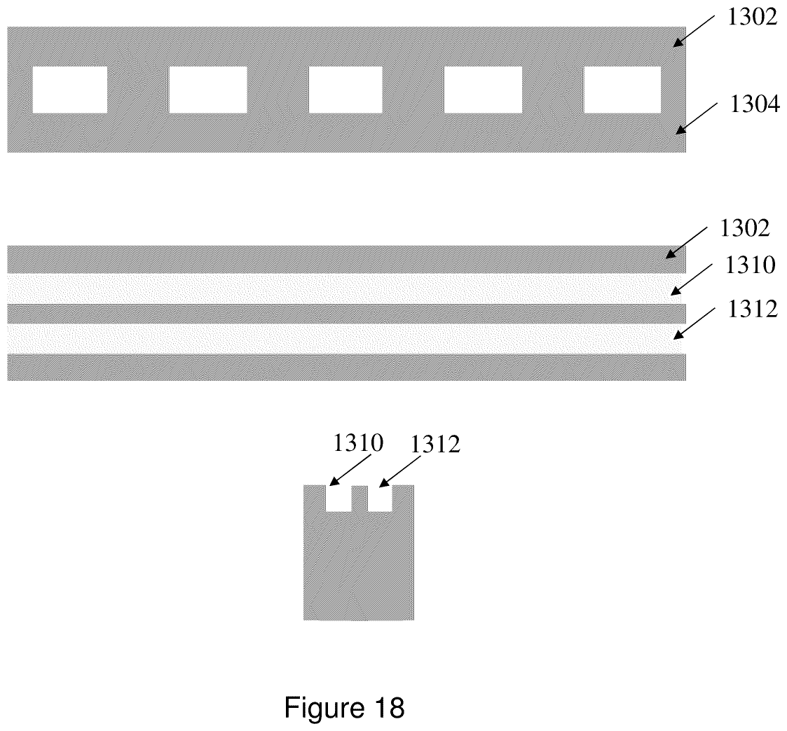

FIG. 18 illustrates a thirteenth implementation of the integrated magnetic apparatus shown in FIG. 5 in accordance with various embodiments of the present disclosure. FIG. 18 shows a cross-sectional view, a top view and a side view of the integrated magnetic apparatus. The thirteenth implementation of the integrated magnetic apparatus is similar to the eighth implementation shown in FIG. 13 except that a second groove 1312 is also formed in the first integrated magnetic core 1302. As shown in FIG. 18, the first groove 1310 is parallel with the second groove 1312.

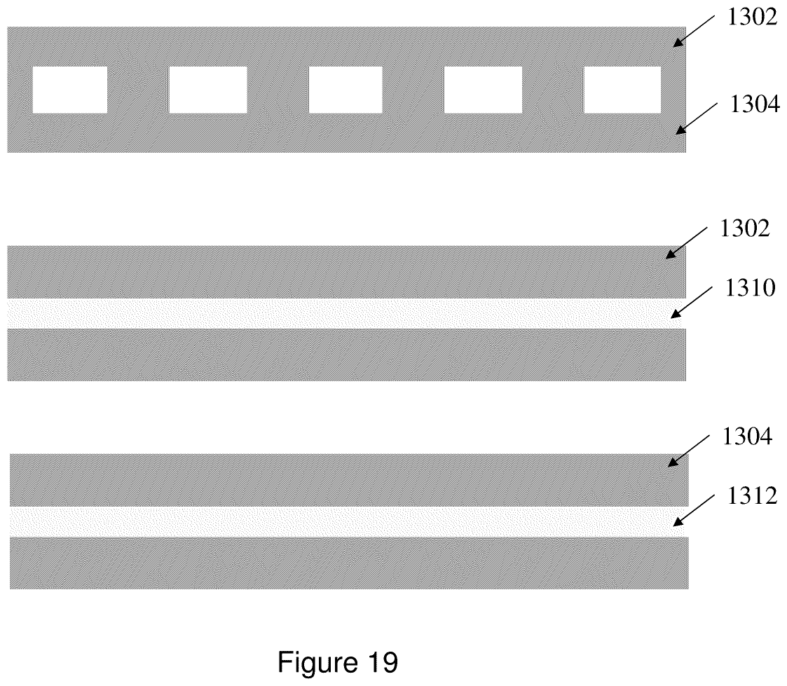

FIG. 19 illustrates a fourteenth implementation of the integrated magnetic apparatus shown in FIG. 5 in accordance with various embodiments of the present disclosure. FIG. 19 shows a cross-sectional view, a top view and a bottom view of the integrated magnetic apparatus. The fourteenth implementation of the integrated magnetic apparatus is similar to the eighth implementation shown in FIG. 13 except that a second groove 1312 is also formed in the second integrated magnetic core 1304. As shown in FIG. 19, the first groove 1310 is parallel with the second groove 1312.

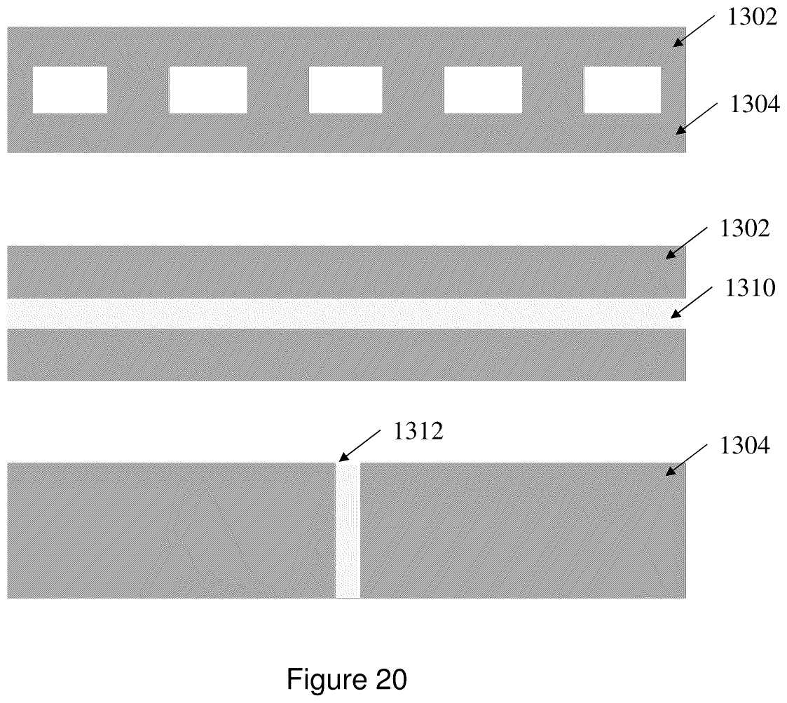

FIG. 20 illustrates a fifteenth implementation of the integrated magnetic apparatus shown in FIG. 5 in accordance with various embodiments of the present disclosure. FIG. 20 shows a cross-sectional view, a top view and a bottom view of the integrated magnetic apparatus. The fifteenth implementation of the integrated magnetic apparatus is similar to the eighth implementation shown in FIG. 13 except that a second groove 1312 is also formed in the second integrated magnetic core 1304. As shown in FIG. 20, the first groove 1310 is orthogonal to the second groove 1312.

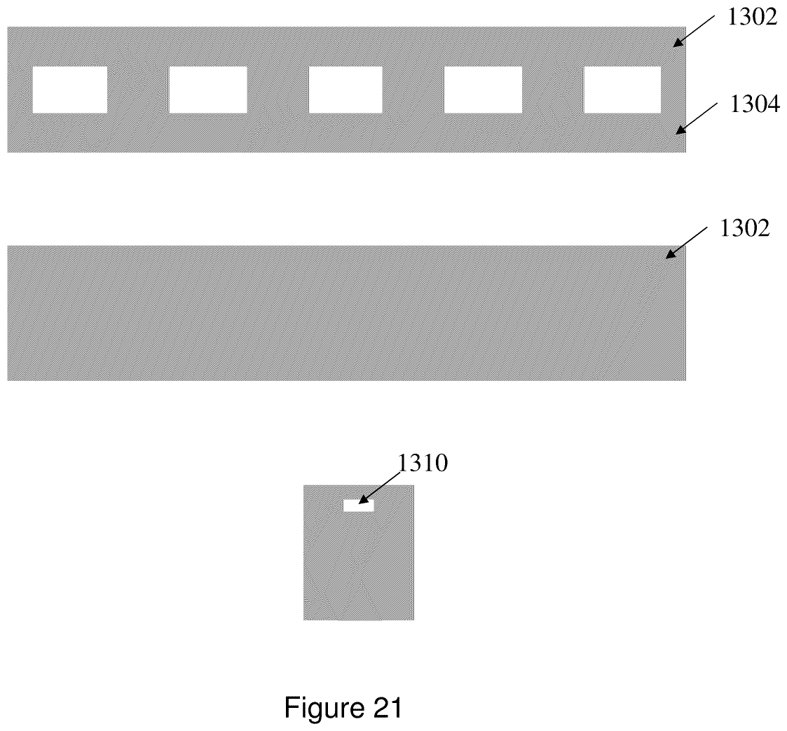

FIG. 21 illustrates a sixteenth implementation of the integrated magnetic apparatus shown in FIG. 5 in accordance with various embodiments of the present disclosure. FIG. 21 shows a cross-sectional view, a top view and a side view of the integrated magnetic apparatus. The sixteenth implementation of the integrated magnetic apparatus is similar to the eighth implementation shown in FIG. 13 except that the groove 1310 is embedded in the first integrated magnetic core 1302.

It should be noted that in the different implementations described above, features described in the context of one embodiment may be used in combination with other embodiments. For example, the gaps shown in FIG. 8 may be used in combination with the embodiment shown in FIG. 13.

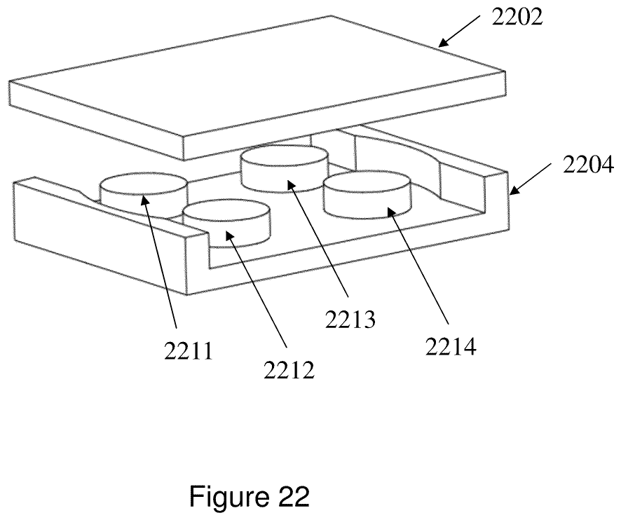

FIG. 22 illustrates another integrated magnetic apparatus having four sections in accordance with various embodiments of the present disclosure. The integrated magnetic apparatus comprises a first integrated magnetic core 2202 and a second integrated magnetic core 2204. As shown in FIG. 22, the first integrated magnetic core 2202 is an I-shaped core. The second integrated magnetic core 2204 has a base, two sidewalls over the base and four columns (legs) 2211, 2212, 2213 and 2214 over the base and between the two sidewalls. These four columns (legs) may be arranged in in two rows as shown in FIG. 22.

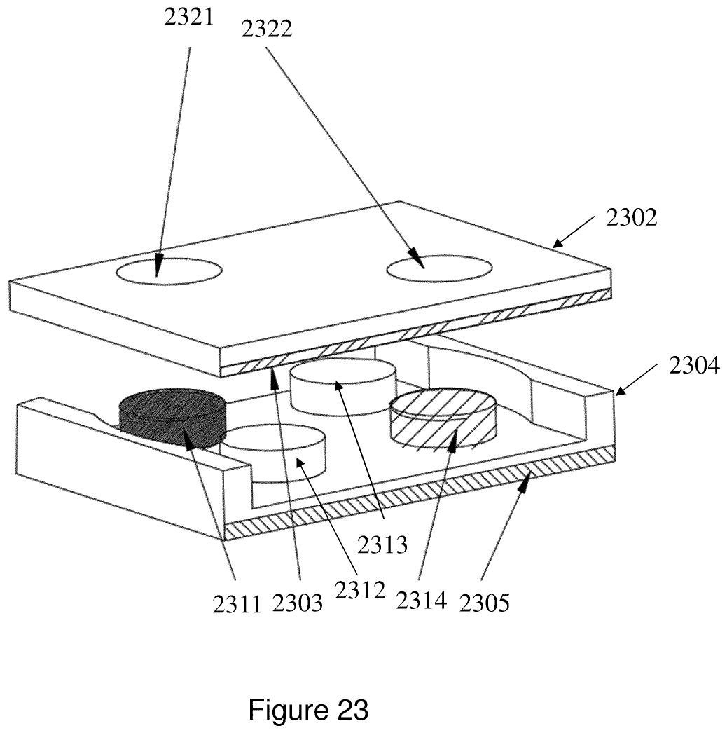

FIG. 23 illustrates a first implementation of the integrated magnetic apparatus shown in FIG. 22 in accordance with various embodiments of the present disclosure. As shown in FIG. 23, the first integrated magnetic core 2302 is an I-shaped core. The second integrated magnetic core 2304 has a base, two sidewalls over the base and four columns (legs) 2311, 2312, 2313 and 2314 over the base and between the two sidewalls. As shown in FIG. 23, these four columns (legs) may be arranged in two rows.

As shown in FIG. 23, the first integrated magnetic core 2302 has a magnetic layer 2303 formed in the lower portion of the first integrated magnetic core 2302. This material of this magnetic layer is different from that of the rest of the first integrated magnetic core 2302. As shown in FIG. 23, the second integrated magnetic core 2304 has a magnetic layer 2305 formed in the lower portion of the second integrated magnetic core 2304. This material of this magnetic layer is different from that of the rest of the second integrated magnetic core 2304.

As shown in FIG. 23, a first opening 2321 is formed over and aligned with a first leg 2311. In some embodiments, the top surface of the magnetic layer 2303 is a bottom of the first opening 2321. A second opening 2322 is formed over and aligned with a fourth leg 2314. In some embodiments, the top surface of the magnetic layer 2303 is a bottom of the second opening 2322. As shown in FIG. 23, the first leg 2311 and the fourth leg 2314 are diagonal to each other.

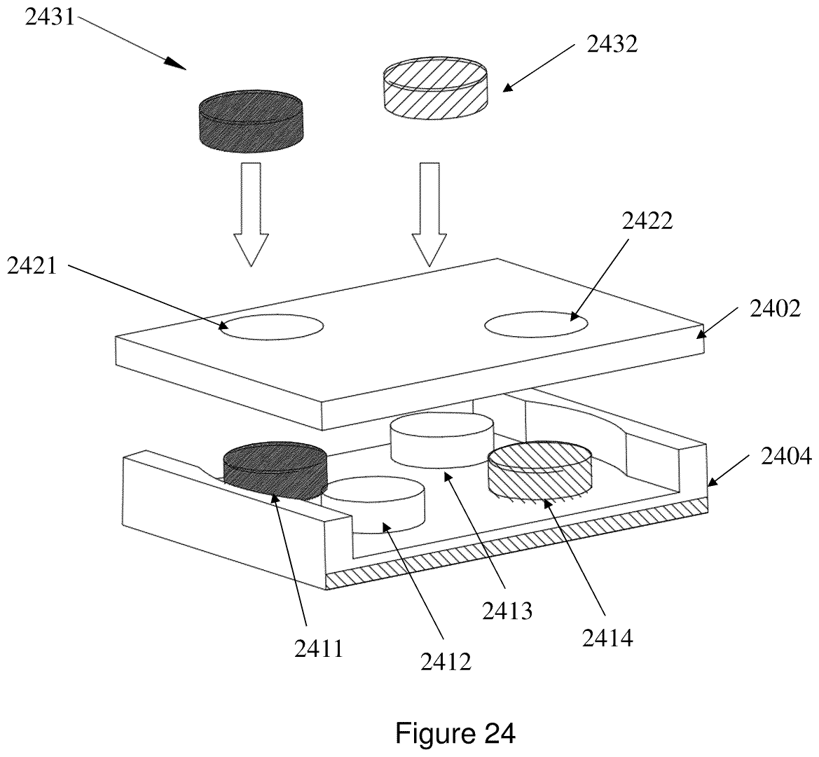

FIG. 24 illustrates a second implementation of the integrated magnetic apparatus shown in FIG. 22 in accordance with various embodiments of the present disclosure. The integrated magnetic apparatus shown in FIG. 24 is similar to that shown in FIG. 23 except that the openings extend through the first integrated magnetic core 2402.

A first opening 2421 is formed over and aligned with a first leg 2411. A first magnetic material 2431 is filled in the first opening 2421. In some embodiments, the first leg 2411 is also formed of the first magnetic material. A second opening 2422 is formed over and aligned with a fourth leg 2414. A second magnetic material 2432 is filled in the second opening 2422. In some embodiments, the fourth leg 2414 is also formed of the second magnetic material.

It should be noted that the implementations shown in FIGS. 8-21 are applicable to the integrated magnetic apparatus shown in FIG. 22. Furthermore, the implementations shown in FIGS. 6-21 are applicable to the integrated magnetic apparatus shown in FIG. 4.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus comprising:
a first integrated magnetic core;
a second integrated magnetic core in direct contact with the first integrated magnetic core, wherein one of the first integrated magnetic core and the second integrated magnetic core comprises a plurality of legs; and
a plurality of windings wound around the plurality of legs, wherein:
the first integrated magnetic core, the second integrated magnetic core and the plurality of windings form a plurality of transformers; and
the first integrated magnetic core and the second integrated magnetic core comprise a plurality of sections, and wherein at least two sections of the plurality of sections are formed of two different magnetic materials.

2. The apparatus of claim 1, wherein:
the plurality of transformers are magnetic devices of a plurality of power converters, and wherein the plurality of power converters forms a distributed power conversion system configured to provide power for a load having a load level up to 2000 amperes.

3. The apparatus of claim 2, further comprising:
a heat sink over the load, wherein the distributed power conversion system is placed underneath the heat sink.

4. The apparatus of claim 1, wherein:
one of the two different magnetic materials is a ferrite material, and the other of the two different magnetic materials is a polycrystalline ferromagnetic material.

5. The apparatus of claim 1, wherein:
one of the two different magnetic materials is a ferrite material, and the other of the two different magnetic materials is a ferromagnetic material.

6. The apparatus of claim 1, further comprising:
a groove in one of the first integrated magnetic core and the second integrated magnetic core.

7. The apparatus of claim 6, wherein:
the groove is embedded in one of the first integrated magnetic core and the second integrated magnetic core, and wherein the groove is configured to adjust a flux direction of the apparatus.

8. The apparatus of claim 6, wherein:
the groove extends through one of the first integrated magnetic core and the second integrated magnetic core, and wherein the groove is configured to adjust a flux direction of the apparatus.

9. The apparatus of claim 6, wherein:
the groove extends partially through one of the first integrated magnetic core and the second integrated magnetic core, and wherein the groove is configured to adjust a flux direction of the integrated magnetic apparatus.

10. The apparatus of claim 6, wherein:
a magnetic material is filled in the groove.

11. The apparatus of claim 10, further comprising:
an electromagnetic interference (EMI) shielding layer coated over the groove.

12. The apparatus of claim 1, further comprising:
a magnetic layer in one of the first integrated magnetic core and the second integrated magnetic core, wherein the magnetic layer is formed from a different magnetic material from the rest of the first integrated magnetic core and the second integrated magnetic core.

13. The apparatus of claim 1, further comprising:
an opening over one leg, wherein the opening is filled with a different magnetic material from the rest of the first integrated magnetic core and the second integrated magnetic core.

14. The apparatus of claim 1, further comprising:
a first opening over a first leg; and
a second opening over a second leg, wherein:
the first opening is filled with a first magnetic material from the rest of the first integrated magnetic core and the second integrated magnetic core; and
the second opening is filled with a second magnetic material from the rest of the first integrated magnetic core and the second integrated magnetic core.

15. The apparatus of claim 1, further comprising:
a first groove in one of the first integrated magnetic core and the second integrated magnetic core; and
a second groove in one of the first integrated magnetic core and the second integrated magnetic core, wherein the first groove is orthogonal to the second groove.

16. The apparatus of claim 1, wherein:
the first integrated magnetic core is an I core; and
the second integrated magnetic core is an E core comprising the plurality of legs arranged in one row.

17. The apparatus of claim 1, wherein:
the first integrated magnetic core is an I core; and
the second integrated magnetic core is an E core comprising the plurality of legs arranged in at least two rows.

18. The apparatus of claim 1, wherein:
the plurality of transformers is magnetic devices of a plurality of power converters, and wherein:
the plurality of power converters forms a distributed power conversion system having an output voltage in a range from about 0.5 V to about 0.6 V; and
each of the plurality of power converters has an input voltage range from 0 V to 48 V.

19. A system comprising:
a plurality of power converters connected between an input voltage bus and an output voltage bus, each of the plurality of power converters comprising at least one magnetic device, wherein a plurality of magnetic devices of the plurality of power converters is formed in an integrated magnetic apparatus comprising:
a first integrated magnetic core;
a second integrated magnetic core in direct contact with the first integrated magnetic core, wherein one of the first integrated magnetic core and the second integrated magnetic core comprises a plurality of legs; and
a plurality of windings wound around the plurality of legs, wherein:
the first integrated magnetic core, the second integrated magnetic core and the plurality of windings form a plurality of transformers; and
the first integrated magnetic core and the second integrated magnetic core comprise a plurality of sections, and wherein at least two sections of the plurality of sections are formed of two different magnetic materials.

20. The system of claim 19, wherein:
each of the plurality of power converters is a fly-forward converter; and
each of the plurality of sections is a leg of the integrated magnetic apparatus, and wherein:
transformer windings of each fly-forward converter are wound around a corresponding leg.
